(19) United States
(12) Patent Application Publication
(10) Pub. No.: US 2002/0187393 A1
(43) Pub. Date: Dec. 12, 2002

(54) Battery terminal and method for its installation on a battery case

(76) Inventors: Venkatasubramanian Ananthanarayanan, Beavercreek, OH (US); Michael Henry Froning, Bellbrook, OH (US); Desra N. Herbst, Dayton, OH (US); Thomas J. Sobztak, Indianapolis, IN (US)

Correspondence Address: DELPHI TECHNOLOGIES, INC., Legal Staff, P.O. Box 5052, Mail Code: 480-414-420, Troy, MI, 48007-5052, US

(21) Appl. No.: 09/875,787

(22) Filed: Jun. 6, 2001

(51) Int. Cl. H01M 2/30

(52) U.S. Cl. 429/178; 429/181; 29/623.1

(57) ABSTRACT

A battery terminal for a battery case is formed with a circumerentially extending shoulder which engages the inner surface of the battery case when the terminal is installed in an aperture in the case by inserting the terminal in the aperture from the inside of the battery case. A retaining ring is then interference resistance welded to the terminal as the retaining ring is pressed into a seated position against the outer surface of the case. An o-ring seal on the shoulder engages the inner surface of the battery case and seals against leakage of the battery acid. High pressure deformation of the battery case and resulting creep are significantly reduced because the force that is used to press the retaining ring against the outer surface of the battery case is relatively low. Furthermore, the welded joint is almost as strong as the material that the terminal is made of and stronger than the plastic battery case.

### TECHNICAL FIELD

This invention relates to a battery terminal for an automotive type storage battery and a method for its installation on the battery case.

### BACKGROUND OF THE INVENTION

Current automotive type storage batteries are equipped with a side terminal which is inserted into the battery case from the outside and includes a shoulder engaging the outer surface of the battery case. The portion of the terminal extending into the battery case is cold worked against the inner surface of the case by a spin riveting operation to form a back “button” where the leads of the battery plates are later welded to the terminal. The button is formed by slowly spinning the terminal down against the case, crimping the terminal against the plastic case and thus forming a tight seal and mechanical bond to the case. This method forms a seam within the terminal where it is rolled over to the inner surface of the case. This is not desirable, because the terminal is overstressed and creep occurs over time to weaken the crimp on the plastic. Furthermore, the seam that is formed within the terminal traps any battery acid that has seeped into it and then causes the terminal to corrode. This corrosion may cause the terminal to fail.

### SUMMARY OF THE INVENTION

According to the present invention, the terminal is formed with a circumerentially extending shoulder which engages the inner surface of the battery case when the terminal is installed in the aperture in the case by inserting the terminal in the aperture from the inside of the battery case. A retaining ring is then interference resistance welded to the terminal as the retaining ring is pressed into a seated position against the outer surface of the case. An o-ring seal on the shoulder engages the inner surface of the battery case and seals against leakage of the battery acid. High pressure deformation of the battery case and resulting creep are significantly reduced because the force that is used to press the retaining ring against the outer surface of the battery case is relatively low. Furthermore, the welded joint is almost as strong as the material that the terminal is made of and stronger than the plastic battery case.

### BRIEF DESCRIPTION OF THE DRAWINGS

FIG. 1 is a fragmentary cross-sectional view of a battery case and battery terminal made pursuant to the teachings of the present invention; and

FIGS. 2-5 illustrate the method steps required to install the battery terminal illustrated in FIG. 1 into the battery case.

### DESCRIPTION OF THE PREFERRED EMBODIMENT

Referring now to the drawings, a battery case generally indicated by the numeral 10 includes a side wall 12 which cooperates with other side walls and a bottom wall (not shown) to form a cavity into which plates are installed (after installation of the battery terminals as described herein) and welded to the battery terminals. The battery is filled with fluid and a top wall (not shown) is sealed to the side walls to complete the battery. Side wall 12 defines an inner surface 14, which faces into the battery case, an outer surface 16, which defines an exterior surface of the battery case, and a terminal aperture 18, which extends between the inner surface 14 and the outer surface 16.

A battery terminal 20 includes a barrel portion 22 which extends through the aperture 18. One end of the barrel portion 22 terminates in a projecting portion 24 which projects from a shoulder 26 which is substantially flush with outer surface 16 of the side wall 12 when the terminal 20 is installed in the aperture 18. The other end of the barrel portion 22 terminates in a circumferentially extending, radially outwardly projecting portion 28, which carries an o-ring seal 30 which circumscribes the aperture 18 and seals against the inner surface 14 of the side wall 12 when the barrel portion 22 is installed in the aperture 18, as will hereinafter be described. The o-ring seal 30 is accordingly effective in preventing leakage of battery acid through the aperture 18. A threaded insert 32 is molded within the terminal 20 and provides threads 34 for connection with a conventional battery cable when the battery is installed in an automotive vehicle.

The terminal is held in place by a circumferentially extending retaining ring 36 which terminates in a transverse surface 38 that is seated against the shoulder 26 and outer surface 16 of the side wall 12. The retaining ring 36 defines an inner circumferential surface 40 (FIG. 2) that is dimensioned to receive outer circumferential surface 42 of projecting portion 24 with an interference fit. As will be hereinafter explained, the retaining ring 36 is seated with sufficient force to assure a leak-tight seal between the o-ring seal 30 and the inner surface 14, but insufficient to overstress the wall 12 and thus potentially causing subsequent creep which may be sufficient to cause leakage of battery acid.

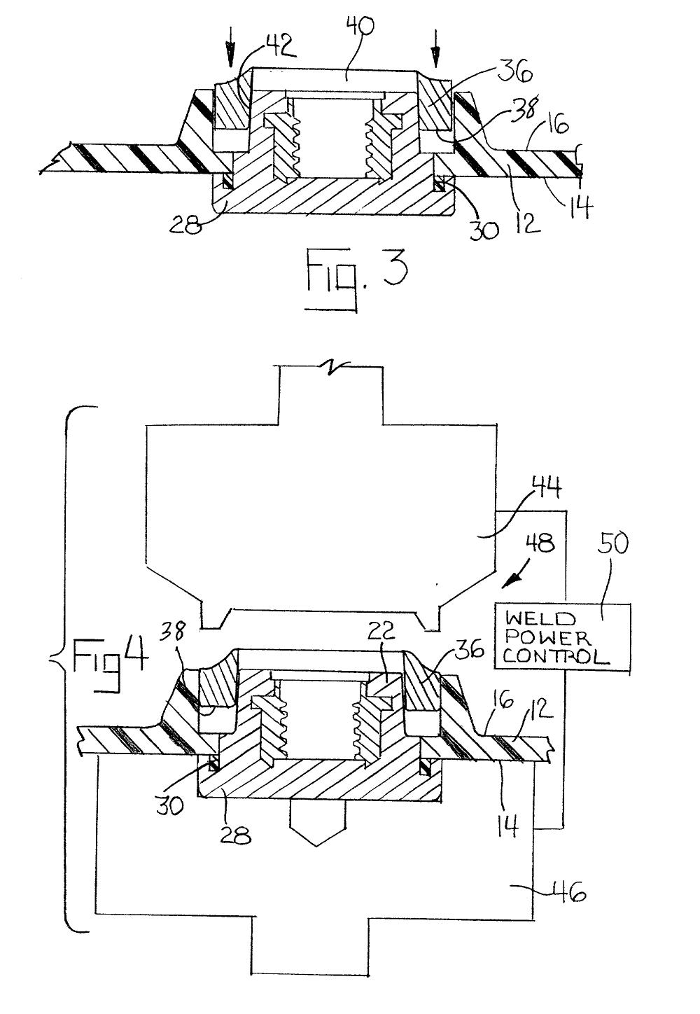

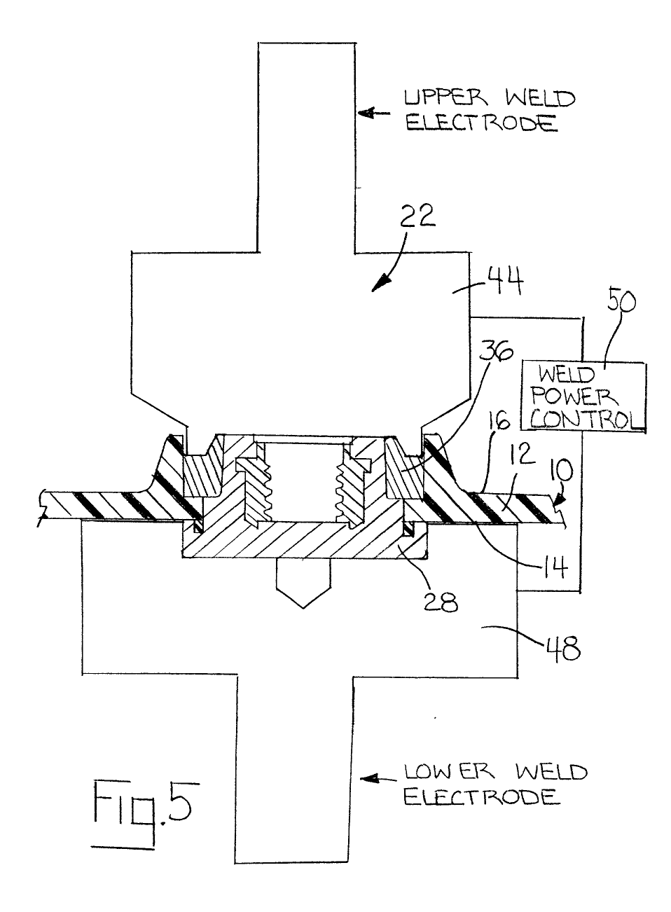

Referring now to FIGS. 2-5, the method by which the terminal 20 is installed on the battery case 10 will be described. The barrel portion 22 of terminal 20 is installed in the aperture 18 from the inside of the battery case 10 and forced from the inner surface 14 toward the outer surface 16 until the 0-ring 30 is seated against the inner surface 14. As discussed above, the circumferential surfaces 40 and 42 are dimensioned such that the retaining ring 36 is received on projecting portion 24 with an interference fit. Accordingly, the retaining ring 36 is then forced onto the projecting portion 24 (see FIGS. 2 and 3) until retaining ring 36 attains an intermediate position illustrated in FIG. 3, in which the transverse surface 38 remains displaced from shoulder 26 and the outer surface 16. The battery case 10 with the terminal 20 installed in aperture 18 and the retaining ring in the intermediate position illustrated in FIG. 3 is then transferred to a bottom electrode 44 of a conventional resistance welding machine generally indicated by the numeral 46 (FIG. 4). The resistance welding machine 46 is conventional, and includes the lower electrode 44, an upper electrode 48, and a controller 50 which controls electrical current through the electrodes 44, 48. The upper electrode is advanced toward the lower electrode in a manner well known to those skilled in the art.

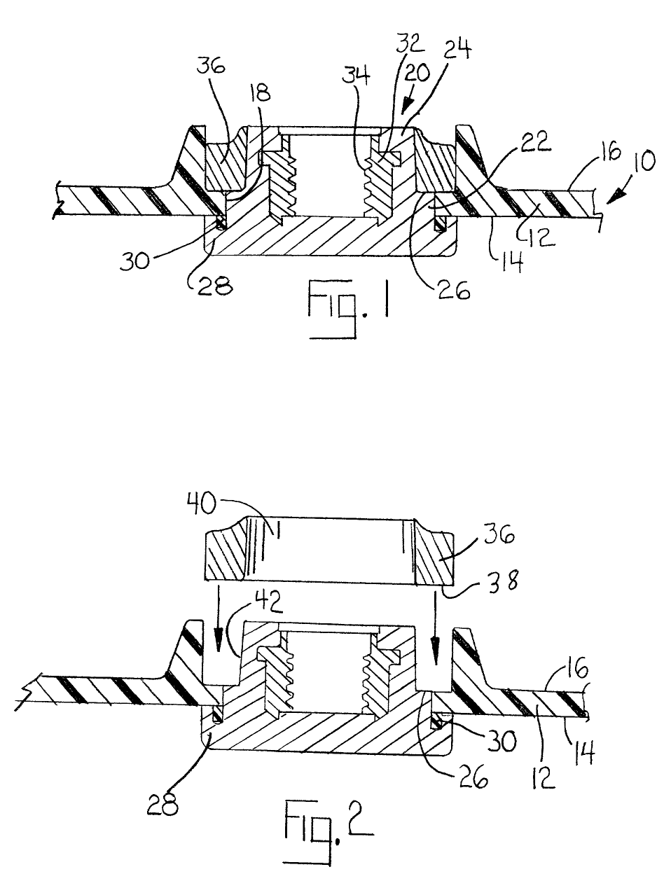

As the upper electrode 48 engages the retaining ring 36 in the intermediate position displaced from the fully seated position, an electrical current controlled by the controller 50 of a magnitude and cycle time readily available to those skilled in the art is caused to flow through the upper electrode 48, the retaining ring 36, the battery terminal 20, and the lower electrode 44. Current flow through the circumferentially extending surfaces 40, 42 causes both of these surfaces to soften, permitting the retaining ring 36 to be forced into the normal seated position illustrated in FIG. 1 in which the transverse surface 38 of the retaining ring 36 is seated against the shoulder 26 and outer surface 16 of the side wall 12 as the electrodes 44, 48 are brought into their fully closed position illustrated in FIG. 5. As the retaining ring 36 is moved into the fully seated position, the softening of the interface between the retaining ring 36 and the terminal 22 causes these components to fuse together, provided a weld that is nearly as strong as the battery case 10 or the battery terminal 20 in themselves. Since the closing force of the electrodes is relatively low, deformation of the battery case and subsequent creep are significantly reduced as compared to prior art devices. Accordingly, sealing against acid leakage through the aperture 18 is improved. Furthermore, the crevices formed in the terminal by the prior art cold working operation, which tended to capture battery acid resulting in corrosion and eventual failure of the terminal, are eliminated.

1. Battery terminal for a battery case, said case having a wall defining an inner surface of said case and an outer surface of said case and an aperture extending between said inner surface of said case and said outer surface of said case, said terminal including a barrel portion defining an outer circumferential surface, said barrel portion extending through said aperture, one end of said barrel portion terminating in an outwardly projecting section projecting from said outer surface of the case when the barrel portion is installed in said aperture and a circumferentially extending, radially outwardly projecting shoulder on the other end of said barrel portion, said shoulder engaging said inner surface of said case when the barrel portion is installed in said aperture, and an annular retaining ring installed on the outwardly projecting section of the barrel portion after the barrel portion is installed in said aperture and having an inner cirumferential surface secured to the outer circumferential surface of said barrel portion, said retaining ring cooperating with said barrel portion to define a radially projecting surface therebetween engaging said outer surface of the case.

2. Battery terminal for a battery case as claimed in claim 1, wherein a circumferentially extending seal carried on said shoulder and circumscribing said barrel portion sealingly engages said shoulder and said inner surface of said case to resist leakage from said case through said aperture.

3. Battery terminal for a battery as claimed in claim 1, wherein said outer circumferential surface of the barrel portion and the inner circumferential surface of said retaining ring are dimensioned to permit the retaining ring to be received on said barrel portion with an interference fit therebetween.

4. Battery terminal for a battery as claimed in claim 1, wherein said retaining ring is welded to said barrel portion.

5. Battery terminal for a battery as claimed in claim 1, wherein said outer circumferential surface of the barrel portion and the inner circumferential surface of said retaining ring are dimensioned to permit the retaining ring to be received on said barrel portion with an interference fit therebetween, the interface between said retaining ring and said barrel portion being fused together.

6. Battery terminal for a battery as claimed in claim 1, wherein said outer circumferential surface of the barrel portion and the inner circumferential surface of said retaining ring are dimensioned to permit the retaining ring to be received on said barrel portion with an interference fit therebetween, the interface between said retaining ring and said barrel portion being welded together with the retaining ring engaging the outer surface of said case.

7. Battery terminal for a battery as claimed in claim 1, wherein said retaining ring is welded to said barrel portion together with the retaining ring engaging the outer surface of said case.

8. Method of installing a battery terminal on a battery case comprising the steps of providing a battery case having an inner surface and an outer surface with an aperture extending between the inner surface and the outer surface, inserting a terminal into said aperture from said inner surface such that a projecting portion of the terminal extends from said outer surface of the battery case and a shoulder on said terminal engages said inner surface of the battery case, and installing a retaining ring on said projecting portion of said terminal.

9. Method as claimed in claim 8, wherein an interference fit exists between the retaining ring and said projecting portion, said method including the step of forcing said retaining ring onto said projecting portion into an intermediate position offset from a final seated position engaging said outer surface of said case.

10. Method as claimed in claim 9, including the step of heating the interface between said retaining ring and said projecting portion, and pressing said retaining ring into the final seated position.

11. Method as claimed in claim 10, wherein said interface is heated by passing an electrical current through said retaining ring and said projecting portion while pressing said retaining ring into said final seated position.

12. Method as claimed in claim 11, wherein said retaining ring and said projecting portion fuse as they are heated by said electric current.

13. Method as claimed in claim 8, wherein the interface between the annular ring and said projecting portion is softened to permit fusing of the projecting portion and the annular ring.

14. Method as claimed in claim 13, wherein said interface is softened by heating said components at said interface.

15. Method as claimed in claim 13, wherein an electrical current is passed through said annular ring and said projecting portion to soften said components at said interface.

16. Method as claimed in claim 15, wherein said retaining ring is pressed into a final seated position engaging said outer surface of said case as said current is passed through said retaining ring and said projecting portion.
